(19) United States
(12) Patent Application Publication
(10) Pub. No.: US 2020/0326025 A1
(43) Pub. Date: Oct. 15, 2020

(54) Fluid-Pressure Assisted Coaxial Fluid Elements, Fittings and Assemblies

(71) Applicant: Jetcool Technologies Inc., Littleton, MA (US)

(72) Inventors: Bernard Malouin, Westford, MA (US); Jordan Mizerak, Boston, MA (US)

(21) Appl. No.: 16/848,690

(22) Filed: Apr. 14, 2020

Related U.S. Application Data
(60) Provisional application No. 62/833,742, filed on Apr. 14, 2019.

(51) Int. Cl. F16L 39/02; F16L 33/16; F16L 33/22

(52) U.S. Cl. CPC F16L 39/02; F16L 33/223; F16L 33/16

(57) ABSTRACT

Coaxial fluid elements that utilize fluid pressure to aid in creating a sealed conveyance of two separate pressurized fluid streams. A coaxial fluid fitting provides a fluid-pressure assisted seal on a coaxial fluid transmission element. Coaxial fluid transmission elements allow two separate fluid flows within the same transmission element: one fluid flow through an interior core region, and a second fluid flow through an exterior annulus region. The fluid flows are separated by an internal wall, fully contained by an external wall, with structural members connecting the two walls. The fluid-pressure assisted coaxial fluid fitting accepts a coaxial fluid transmission element, providing seals between the two fluid flows as well as to the surrounding environment. The interior seal is fortified by situating a higher pressure fluid in the exterior annulus region, providing an inward sealing force without the use of a mechanical sealing aid. This enables transmission systems of pressurized fluids that are smaller in size and contain fewer points of failure, compared to standard systems with single fluid stream transmission elements and fluid transmission systems containing other multi-lumen transmission elements.

### CROSS-REFERENCE TO RELATED APPLICATION

This application claims priority of Provisional Application 62/833,742, filed on Apr. 14, 2019, the entire disclosure of which is incorporated herein by reference for all purposes.

### BACKGROUND

This disclosure relates to fluid transmission systems.

Fluid transmission systems are employed in a variety of engineering industries, including medical, defense, manufacturing, and many others. From a broad viewpoint, fluid transmission systems have at least three unique types of elements: components, where some action is performed to/by the fluid (pumps, heat exchangers, filters, etc.); transmission elements, where fluid is transported between components (tubes, pipes, hoses, etc.); and fittings, where fluid is interfaced between transmission elements and components (hose barbs, compression fittings, quick disconnect fittings, Leuer fittings, pipe fittings, etc.). Standard fluid transmission systems utilize transmission elements and fittings that contain a single fluid flow.

In engineering systems, it is often desired to minimize size, reduce complexity, and minimize the potential number of points of failure for robust systems. In a standard fluid transmission system, there is a potential point of failure with each transmission element and each fitting. In a closed-loop two-component fluid transmission system, for example, there would be four fittings and two transmission elements to convey the fluid between the two components, totaling six potential points of failure. Additionally, each fitting and transmission element takes up space, which can be a limiting factor in many engineering systems.

A fluid transmission system containing multi-lumen transmission elements may offer improvements over standard fluid transmission systems. Multi-lumen transmission elements are single elements containing multiple lumens, where each lumen is a separate passageway for the conveyance of fluid, cables, equipment, or other elements. For the purpose of this disclosure, two lumen types will be considered: lumens of circular cross section, and lumens of non-circular cross section.

In certain embodiments, multi-lumen fluid transmission elements contain at least two lumens of circular cross section to provide fluid passage of at least two separate fluid streams in a single transmission element. This results in a reduction of the number of transmission elements in a fluid transmission system, which may allow for a reduction in system size and number of points of failure. However, each of these lumens containing a separate fluid stream typically requires its own separate fluid fitting.

In other embodiments, multi-lumen transmission elements may contain a mix of lumens of circular cross section and lumens of non-circular cross section. Lumens of circular and non-circular cross section may provide transmission of fluids, cameras, mechanical tools, electrical wires, or others. Regardless of shape, each lumen containing a separate fluid stream typically requires its own separate fitting.

Multi-lumen transmission elements typically do not contain highly pressurized fluids. Often in the medical industry, for example, fluids of very low pressure are transmitted to and from the body. These fluids may be less than 10 pounds per square inch gauge (PSIg) pressure, to avoid bodily damage in the case of a seal failure (cf blood pressure ˜1-4 PSIg). In other engineering systems, fluids are pressurized much higher, for example, routinely greater than 50 PSIg. Some engineering systems may reach pressures over 200 PSIg, or 1000 PSIg, for example.

The difficulty of utilizing multi-lumen transmission elements in highly pressurized systems is creating high quality seals when interfacing with a fitting. For standard systems with pressurized fluid, there is often a mechanical aid applied to the exterior of the fluid transmission element to apply a sealing force. Examples of mechanical aids may include hose clamps, compression nuts, external o-rings, and others. In multi-lumen transmission elements, the surrounding lumens and separating material make it difficult to apply these mechanical aids to each individual fluid stream, thereby limiting the operating pressure inside the lumens. Additionally, many fluid fittings for multi-lumen tubes are designed for lumens of circular cross section, which makes fluid transmission in lumens of non-circular cross sections even more challenging.

### SUMMARY

The present disclosure allows for the transmission of highly pressurized fluids in multi-lumen transmission elements containing lumens of circular and non-circular cross sections, to enable systems of reduced size, reduced number of points of failure, and reduced complexity. In an example these results can be accomplished with carefully designed coaxial fluid transmission elements and coaxial fluid fittings.

All examples and features mentioned below can be combined in any technically possible way.

In one aspect a fluid-pressure assisted coaxial fluid fitting, configured to accept a coaxial fluid transmission element, includes a first, interior seal, configured to seal a circular interior region of a coaxial fluid transmission element containing a fluid at a first pressure and a second, exterior seal, configured to seal at least one exterior non-circular region of a coaxial fluid transmission element containing a fluid at a second pressure higher than the first pressure. The fluid at the second, higher pressure provides a fluid-pressure assist on the first interior seal.

Some examples include one of the above and/or below features, or any combination thereof. In an example the interior seal is formed by a fluid-pressure assisted barb type connection. In an example the exterior seal is formed by a push-to-connect type connection. In an example the exterior seal is formed by a compression type connection. In an example the fluid-pressure assisted coaxial fluid fitting is configured to serve as an adapter to interface with two standard single-lumen transmission elements. In an example the fluid-pressure assisted coaxial fluid fitting forms part of a fluidic component such that the fluid fitting and fluidic component are a unitary structure. In an example the fluid-pressure assisted coaxial fluid fitting is configured to interface with a fluidic component via a gasket seal. In an example the fluid-pressure assisted coaxial fluid fitting is configured to interface with a fluidic component via a threaded connection.

In another aspect an assembly includes a coaxial fluid transmission element with an interior circular core region containing a fluid at a first pressure and at least one exterior non-circular region, surrounding at least most of the interior core region, containing a fluid at a second pressure that is higher than the first pressure. A fluid-pressure assisted coaxial fluid fitting, configured to accept the coaxial fluid transmission element, comprises a first interior seal, configured to seal the circular interior region of the coaxial fluid transmission element containing the fluid at the first pressure, and a second exterior seal, configured to seal the at least one exterior non-circular region of the coaxial fluid transmission element containing a fluid at the second pressure higher than the first pressure. The fluid at the second, higher pressure provides a fluid-pressure assist on the first seal.

Some examples include one of the above and/or below features, or any combination thereof. In an example the coaxial fluid fitting further comprises mechanical features that are configured to align the coaxial fluid transmission element with the coaxial fluid fitting upon insertion of the coaxial fluid transmission element into the coaxial fluid fitting. In some examples the assembly is configured to be an adapter between a coaxial tube and at least two standard tubes that each comprise a single lumen, and further includes a first standard tube containing a fluid at the first pressure, a second standard tube, containing a fluid at the second pressure higher, a first standard fitting, providing a seal for the first standard tube, and a second standard fitting, providing a seal for the second standard tube. The first fitting provides transmission of the fluid in the first standard tube at the first pressure to the interior circular core region. The second fitting provides transmission of the fluid in the second standard tube at the second pressure to the at least one non-circular region. In an example the first and second standard fluid fittings are of the same type. In an example the first and second standard fluid fittings are of different types. In an example at least one of the first and second standard fluid fittings is a non-fluid-pressure assisted barb fitting. In an example at least one of the first and second standard fluid fittings is a compression fitting. In an example at least one of the first and second fluid fittings is a push-to-connect fitting. In an example at least one of the first and second standard fluid fittings is a quick disconnect fitting.

In another aspect a coaxial fluid transmission element includes an interior circular core region containing a fluid at a first pressure and at least one exterior non-circular region, surrounding the interior core region, containing a fluid at a second pressure that is higher than the first pressure.

Some examples include one of the above and/or below features, or any combination thereof. In an example the coaxial fluid transmission element is made out of a material with low thermal conductivity to reduce heat transfer between fluid streams of different temperatures. In an example the coaxial fluid transmission element comprises an inner wall that separates the interior region from the at least one exterior region, and an outer wall that defines the outside of the at least one exterior region, with at least one structural member in between the internal wall and external wall. In some example the internal wall and the external wall are made of different material. In an example the material of the internal wall is compatible with a hose barb type connection. In an example the material of the external wall is compatible with a push-to-connect type connection. In an example the material of the external wall is compatible with a compression type connection. In an example the material of the internal wall is a material with low thermal conductivity to inhibit heat transfer between fluid streams of different temperatures.

### BRIEF DESCRIPTION OF THE DRAWINGS

For a better understanding of the present disclosure, reference is made to the accompanying drawings in which:

FIG. 1 shows a prior art two-component fluid transmission system, which has two transmission elements and four fittings.

FIG. 2 shows a two-component coaxial fluid transmission system, which has one transmission element and two fittings.

FIG. 3A shows an isometric view of one embodiment of a coaxial fluid transmission element, FIG. 3B shows a cross section cutaway view taken along line 3B-3B, FIG. 3A, and FIG. 3C shows a top view thereof.

FIG. 4A shows an isometric view of one embodiment of a fluid-pressure assisted coaxial fluid fitting, FIG. 4B shows a cross sectional view taken along line 4BC-4BC, FIG. 4A, and FIG. 4C shows an exploded cross section cutaway view taken along line 4BC-4BC, FIG. 4A.

FIG. 5A shows an isometric view of one embodiment of an assembly containing a coaxial fluid transmission element with the fluid-pressure assisted coaxial fluid fitting, FIG. 5B shows a cross sectional view taken along line 5B-5B, FIG. 5A, and FIG. 5C shows an exploded view thereof.

FIG. 6 shows a cross sectional view of another embodiment, where the fluid-pressure assisted coaxial fluid fitting is built into a component.

FIG. 7 shows a cross sectional view of another embodiment, where the fluid-pressure assisted coaxial fluid fitting is sealed to a component of interest by some method of attachment.

FIG. 8 shows a hybrid coaxial/single stream fluid transmission system.

FIG. 9A shows an isometric view of another embodiment, where the fluid-pressure assisted coaxial fluid fitting is integrated into an adapter from a coaxial fluid transmission element to two standard single fluid flow transmission elements, FIG. 9B shows a cross sectional view taken along line 9B-9B, FIG. 9A, and FIG. 9C shows an exploded view thereof.

FIG. 10A shows an isometric view of an assembly of an adapter embodiment, containing a pressure-assisted coaxial fluid fitting interfacing a coaxial fluid transmission element to two standard fluid transmission elements with standard fluid fittings, and FIG. 10B shows a cross sectional view taken along line 10B-10B, FIG. 10A.

FIG. 11A shows an isometric view of another embodiment, where the exterior seal is of compression type instead of type push-to-connect, FIG. 11B shows a cross sectional view taken along line 11B-11B, FIG. 11A, and FIG. 11C shows a cross section cutaway view thereof.

### DETAILED DESCRIPTION

This disclosure describes utilizing coaxial fluid elements that induce a fluid-pressure sealing assist, providing high quality seals to multi-lumen transmission elements containing pressurized fluids.

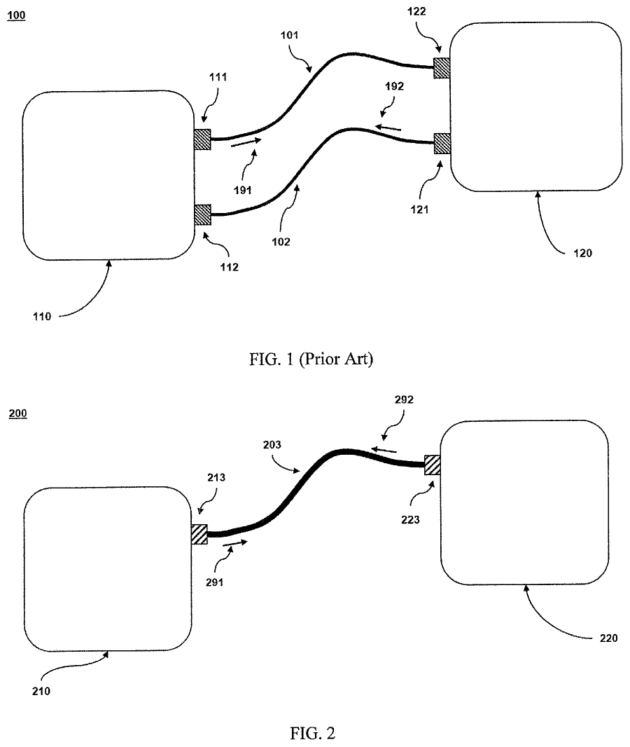

FIG. 1 shows a prior art standard closed-loop fluid transmission system 100, an understanding of which is useful to help understand aspects of the present disclosure. Fluid transmission system 100 has two components 110 and 120. The fluid, for example, begins in component 110, passes through standard fitting 111, and enters into standard transmission element 101, traveling toward component 120 in fluid stream 191. The fluid then passes through standard fitting 122 and enters component 120. Upon exiting component 120, the fluid passes through standard fitting 121 into standard transmission element 102, traveling back toward component 110 in fluid stream 192. The fluid then passes through standard fitting 112, re-entering component 110, at which point the closed-loop fluid system repeats. Note that the fluid from stream 191 is the same as the fluid from stream 192, but is separate, traveling in the opposite direction, switching from stream 191 to stream 192 as it passes through component 120.

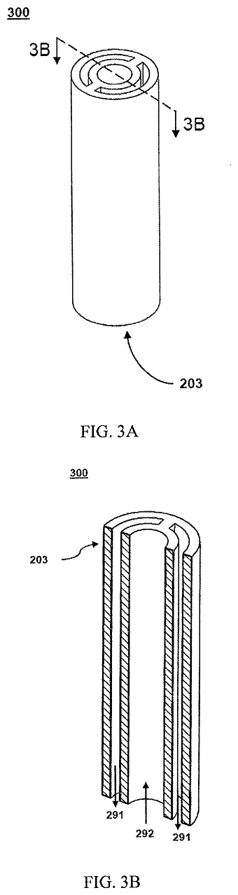

FIG. 2 shows an embodiment of a two-component coaxial fluid transmission system 200 of the present disclosure. The fluid, for example, begins in component 210, passes through coaxial fluid fitting 213, and enters into coaxial transmission element 203, traveling toward component 220 in fluid stream 291. The fluid then passes through coaxial fitting 223 and enters component 220. Upon exiting component 220, the fluid passes back through coaxial fitting 223, separately from fluid stream 291, back into coaxial transmission element 203, traveling back toward component 210 in separate fluid stream 292. The fluid then passes back through coaxial fitting 213, separately from fluid stream 291, re-entering component 210, at which point the closed-loop fluid system repeats. Note that the fluid from stream 291 is the same as the fluid from stream 292, but is separate, traveling in the opposite direction, switching from stream 291 to stream 292 as it passes through component 220.

In two-component coaxial fluid transmission system 200, there are only three potential points of failure, as there are two coaxial fittings and one coaxial transmission element, replacing four standard fittings and two standard transmission elements as seen in standard transmission system 100. This also improves upon the previously described multi-lumen fluid transmission systems, as coaxial system 200 has one fitting 213 on each end of multi-lumen tube 203, as opposed to one fitting on each end for each separate lumen of multi-lumen tube 203.

Additionally, although each individual fitting and transmission element will be slightly larger than a corresponding standard element, the net effect will be reduced size by removing elements from the system and more economized use of space in combined elements. The system may also have less complexity, as there are fewer components to allocate and position in the system, and fewer installation steps, for example.

This disclosure can additionally contain highly pressurized fluids, an improvement over multi-lumen systems that can only apply fittings without an exterior mechanical aid to strengthen the seal.

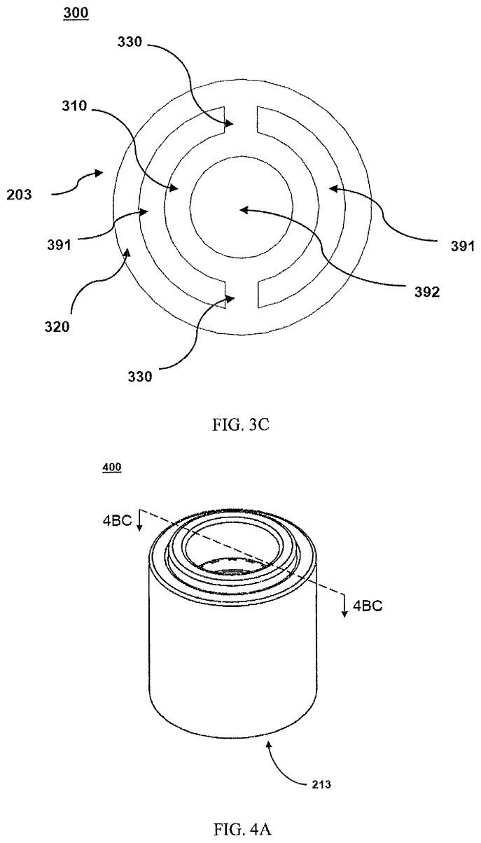

An embodiment 300 of a coaxial fluid transmission element 203 is shown in FIGS. 3A-3C. FIG. 3A depicts an isometric view. FIG. 3B shows a vertical cross section cutaway view. FIG. 3C shows a top view.

Separate fluid flows 291 and 292, as illustrated in FIG. 2, travel in the coaxial fluid transmission element 203. In an example fluid stream 292 travels in the interior core region 392 in one direction, while fluid stream 291 travels in the exterior annulus region 391 in the other direction. Note that in this embodiment, in conjunction with FIG. 2, the fluid streams 291 and 292 travel in opposite directions; there may be embodiments where fluid streams 291 and 292 travel in the same direction. Note also that in this embodiment interior fluid 292 is traveling up, and exterior fluid 291 is traveling down; either fluid may travel in either/any direction.

Interior core region 392, a lumen of circular cross section, is surrounded by an internal wall 310, which separates it from exterior annulus region 391, two lumens of non-circular cross section. Exterior annulus region 391 is contained within an external wall 320, enclosing the entire element.

There may be at least one structural member 330 between internal wall 310 and external wall 320. The number of structural members 330 may be related to the number of lumens in the coaxial fluid transmission element 203. For example, FIGS. 3A-3C show two structural members, resulting in a transmission element with three lumens: one of circular cross section in the interior core region 392, and two of non-circular cross section in the exterior annulus region 391. In another embodiment, there may be three structural members, resulting in four lumens: one of circular cross section in the interior core 392, and three of non-circular cross section in the exterior annular region 391. A coaxial fluid transmission element 203 with any number of lumens may be used. This disclosure focuses on but is not limited to a single, axially centered circular lumen 392 for one fluid stream 292, and a collection of partially annular lumens 391 separated by structural members 330 for another fluid stream 291. However, the following principles may be applied similarly to alternative arrangements and shapes of lumens.

Coaxial fluid transmission element 203 may be manufactured using an extrusion technique. The coaxial fluid transmission element may be made out of any standard transmission element material, such as a flexible plastic, a rigid plastic, a rubber, a metal, or any other suitable material.

Alternatively, a co-extrusion technique may be applied, where two compatible materials are extruded together to make a single element. Co-extrusion may be applied to combine compatible materials such that the internal wall 310 and the external wall 320 have different material properties.

For example, as may be applied in certain embodiments, a co-extrusion could entail a material for internal wall 310 compatible with one type of fitting connection, such as a hose barb, with a material for external wall 320 compatible with another type of fitting connection, such as a push-to-connect or compression connection. Other embodiments may entail combinations of materials compatible with other types of fitting connections.

As another example, in the case of a system with fluid streams of different temperatures, the entire coaxial fluid transmission element 203 may be made of a material that has low thermal conductivity. Alternatively, co-extrusion may be applied, where the material of internal wall 310 may be of low thermal conductivity, while the material of structural members 330 and external wall 320 may be of a compatible material with any thermal conductivity.

In other systems, materials with different properties may be co-extruded to achieve other desired performance, such as a target weight, structural integrity, flexibility, or others.

In this embodiment, the cross sectional areas of interior core 392 and exterior annulus 391 are approximately equal. In other embodiments, the cross sectional area of interior core 392 may be larger, smaller, or equal to the cross sectional area of exterior annulus 391. Because the area of a circle increases with the diameter squared, the exterior annulus 491 may have a notably smaller gap thickness than the radius of the interior core 492 while still achieving the same cross sectional area. The diameters are carefully selected to balance transmission element size, structural integrity, and pressure drop, but may be, for example, ˜0.2″ interior diameter, ˜0.5″ inner annulus diameter, and ˜0.6″ outer annulus diameter. The diameters may be significantly larger or smaller depending on the system flow rate, available pressure head, and other system performance requirements.

The wall thicknesses of coaxial transmission element 203 may vary. In this embodiment, the thicknesses of walls 310 and 320 are approximately equal. In other embodiments, the thickness of internal wall 310 may be thicker, thinner, or the same thickness as external wall 320. The wall thicknesses, in conjunction with the diameters of the interior core 392 and exterior annulus 391, may be carefully chosen to balance fitting size and structural integrity, but may be, for example, approximately 0.1″ thick.

The following description introduces a fluid-pressure assisted coaxial fluid fitting, providing high quality seals for coaxial fluid transmission element 203 containing pressurized fluids,

Separate fluid streams in fluid transmission systems are often at different pressures. For example, in standard fluid transmission system 100, fluid streams 191 and 192 are often at different fluid pressures. If component 110 were a pump, for example, the pressure would be highest at standard fitting 111 and decrease as the fluid flows through the system due to various pressure losses, such as frictional losses, expansion losses, gravitational losses, acceleration losses, and others. Very often, the pressure of a fluid drops after it passes through a component, such as component 120. Therefore, in the described example, the fluid pressure in fluid stream 192 would be lower than the fluid pressure in fluid stream 191.

Similarly, in coaxial fluid transmission system 200, the fluid pressure in fluid stream 291 in the exterior annulus 391 of coaxial fluid element 203 may be different than the fluid pressure in fluid stream 292 in the interior core 392. Depending on the configuration of components applied in fluid transmission system 200, either fluid stream may be at a higher pressure. This disclosure focuses on instances in which fluid stream 291, in the exterior annulus 391, is at a higher pressure than fluid 292, in the interior core 392.

When there is an interface with two fluids of different pressures, the pressure differential causes a net force on the interface in the direction towards the fluid of lower pressure.

Therefore, in a coaxial transmission element 203, a higher pressure fluid 291 in the exterior annulus 391 will result in a net inward force. This pressure differential is currently not utilized in standard fluid transmission systems, as the two fluid streams are in separate fluid transmission elements 101 and 102. Fittings 111, 112, 121, and 122 typically use a mechanical aid on their exterior to provide a high-quality seal.

However, in a coaxial fluid transmission element 203, the two fluid streams 291 and 292 are no longer separated by appreciable distance. A mechanical aid can be used to provide a high quality exterior seal as is done for standard transmission elements. However, where normally the external wall 320 and exterior annulus region 391 would interfere with a mechanical aid for the interior seal, the inward force from the fluid pressure differential can be used to replace a mechanical aid, and therefore produce a high-quality interior seal. Put another way, instead of applying a physical mechanical aid to provide a sealing force on the interior seal, the pressure differential between high pressure fluid 291 in the exterior annulus 391 and low pressure fluid 292 in the interior core 392 provides a sealing force to strengthen the interior seal.

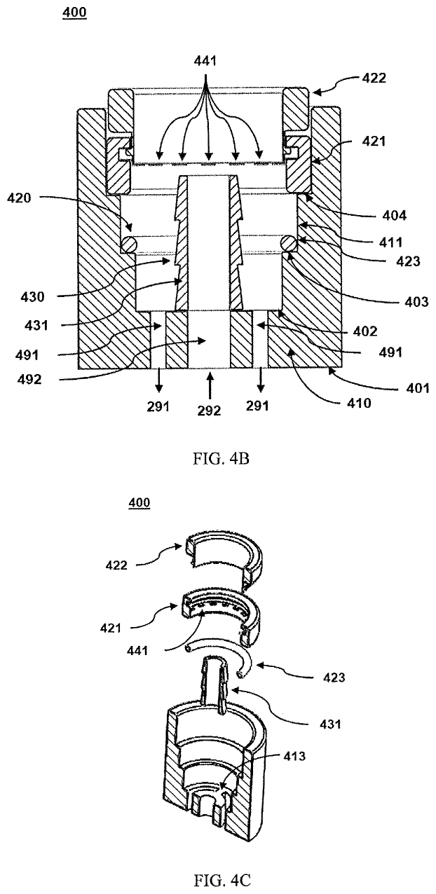

FIGS. 4A-4C show an embodiment 400 of a fluid-pressure assisted coaxial fluid fitting 213. FIG. 4A shows an isometric view. FIG. 4B shows a cross sectional view. FIG. 4c shows an exploded cross section cutaway view.

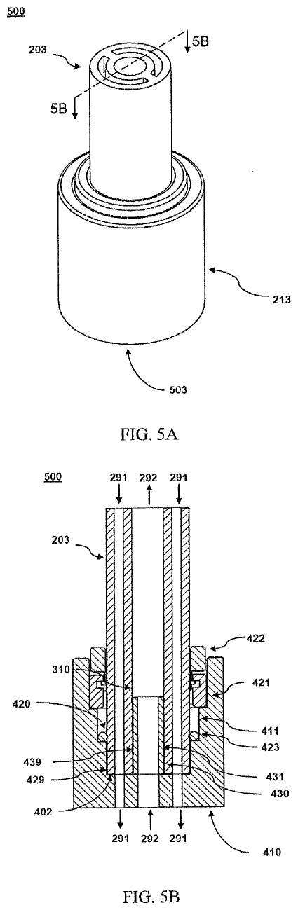

FIGS. 5A-5C show an embodiment 500 of an assembly 503 containing the coaxial fluid element 203 inserted in the fluid-pressure assisted coaxial fluid fitting 213. FIG. 5A shows an isometric view. FIG. 5B shows a cross sectional view. FIG. 5C shows an exploded view.

In the example illustrated in FIGS. 4A-4C and 5A-5C, the pressure-assisted coaxial fluid fitting 213 applies two sealing types: a standard push-to-connect type connection 420 for the exterior seal, and a fluid-pressure assisted barb connection 430 for the interior seal.

First looking at FIGS. 4A-4C, The main body 410 of fluid-pressure assisted coaxial fluid fitting 213 has six major features, best seen by looking at FIGS. 4B and FIG. 4C. For the purpose of explanation, all features are azimuthally symmetric unless otherwise noted.

The first feature is an interior core passageway 492 where fluid stream 292 travels through coaxial fitting 213. This passage passes through the bottom surface of the main base 401, past tube-stop surface 402, and all the way up through hose barb 431. This passage corresponds to the interior core region 392 of coaxial fluid transmission element 203 containing fluid stream 292.

The second feature is an exterior annular passageway 491 where fluid stream 291 travels through coaxial fitting 213. This passage passes through the bottom surface of the main base 401 up to tube-stop surface 402. This passage corresponds to the exterior annular region 391 of coaxial fluid transmission element 203 containing fluid stream 291.

The third feature is a tube-stop surface 402. As seen in FIG. 5B, this is a physical stop point for an inserted coaxial fluid transmission element 203. As will be discussed in greater detail shortly, this is part of a mechanism to produce seal 439 between exterior fluid stream 291 and interior fluid stream 292, as well as part of a mechanism to produce seal 429 between exterior fluid stream 291 and the surrounding environment.

The fourth feature is an o-ring surface 403, on which sits an o-ring 423. As will be discussed in greater detail shortly, this is part of a mechanism to produce seal 429 between exterior fluid stream 291 and the surrounding environment.

The fifth feature is a grasping ring surface 404, on which sits a grasping ring 421, which subsequently mates with release ring 422. As will be discussed in greater detail shortly, this is part of a mechanism to produce seal 439 between exterior fluid stream 291 and interior fluid stream 292, as well as part of a mechanism to produce seal 429 between exterior fluid stream 291 and the surrounding environment.

The sixth feature is a hose barb 431. As will be discussed in greater detail shortly, this is part of a mechanism to produce seal 439 between interior fluid stream 292 and exterior fluid stream 291.

Note that there is at least one structural member 413 between interior passageway 492 and exterior passageway 491, making the main body 410 all one connected part. In certain embodiments, the structural members 413 of coaxial fluid fitting 213 may match the structural members 330 of the coaxial fluid transmission element 203 in cross section to avoid interrupting fluid stream 291 in the exterior annulus 391. These features, therefore, would not be azimuthally continuous but may be in a regular azimuthal pattern.

Now looking at FIGS. 5A-5C, the coaxial fluid fitting 213 serves to provide high quality seals for the coaxial fluid transmission element 203 via two connection types.

The first connection 420 provides a seal 429 between exterior fluid stream 291 and the surrounding environment when coaxial fluid transmission element 203 is inserted. The push-to-connect connection 420 establishes its seal 429 by compressing an o-ring 423 against the wall 411 of the main body 410. Grasping ring 421 grabs the coaxial fluid transmission element 203 with uniform azimuthally distributed grasping teeth 441, which holds the coaxial transmission element in place. This serves to prevent the transmission element 203 from losing contact with tube-stop surface 402, which would weaken the fluid seal. Release ring 422 can be pushed downward to disengage the grasping teeth 441 on grasping ring 421 to remove the coaxial fluid transmission element 203 should disassembly be required. Push-to-connect seals 429 of this type may have pressure ratings greater than 300 PSIg.

The second connection 430 provides a seal 439 between interior fluid stream 292 and exterior fluid stream 291 when coaxial fluid transmission element 203 is inserted. The fluid-pressure assisted barb connection 430 establishes its seal 439 via two contributions.

First, the internal wall 310 of coaxial fluid transmission element 203 creates an interference fit on the hose barb 431, utilizing the internal material stress of the expanded internal wall to provide a small inward sealing force.

Second, the pressure differential between high pressure fluid stream 291 and low pressure fluid stream 292 provides a fluid-pressure assist to enhance the seal 439. Due to the pressure difference between fluid stream 291 in exterior annulus 391 and fluid stream 292 in interior core 392, a net inward force is applied to internal wall 310 on hose barb 431 to strengthen the sealing force.

The magnitude of this force is based on the pressure difference between fluid streams 291 and 292, and the geometry of the hose barb 431. For a given system, a fluid-pressure assisted coaxial fluid fitting can be systematically designed, with constraints, to provide a desired sealing force. For example, a larger pressure difference between fluid stream 292 and fluid stream 291 may be administered to induce a larger sealing force. Additionally, various geometric parameters of the hose barb may be carefully chosen to induce a larger or smaller sealing force, in conjunction with the pressure difference. Such parameters may include, for example, the number of barbs, barb vertical thickness, barb taper angle, and others.

In certain embodiments, coaxial fluid transmission elements 203 may have uniformly azimuthally distributed structural members 330 to produce uniform azimuthally distributed exterior annular lumens, thereby applying a symmetric inward force for a uniform azimuthal seal.

In one embodiment, the fitting body 410 is made of a metal, but may be made of plastic, or any other suitable material. Standard or custom-sized o-rings 423 may be applied. The grasping ring 421 may be made of metal, plastic, or any other suitable material. In one embodiment, the release ring 422 may be made out of plastic, but may be made out of any suitable material. The fitting and its components may be 3D printed, conventionally machined, molded, cast, or fabricated with any other suitable method.

The illustration in FIG. 4 may imply a certain set of sizes based on traditional off-the-shelf components, but the fluid-pressure assisted coaxial fluid fitting 213 may be of any size. In one embodiment, coaxial fluid fitting 213 may accept a coaxial fluid transmission element 203 with an outside diameter compatible with standard imperial or metric push-to-connect fittings 420. In other embodiments, push-to-connect connection 420 may be of a non-standard size. In one embodiment, coaxial fluid fitting 213 may accept a coaxial fluid transmission element 203 with an inner diameter compatible with standard imperial or metric hose barb connection 430. In other embodiments, hose barb connection 430 may be of a non-standard size. Likewise, coaxial fluid fitting 213 may accept coaxial fluid transmission elements 203 with inner and outer diameters of non-standard sizes.

In this embodiment, there are two structural members 413 (one not shown in cross section). There may be more than two structural members 413, which may or may not match with structural members 330 in coaxial fluid transmission element 203. The structural members may be of any suitable size and be distributed in any suitable manner to provide a structurally sound base 410 of the coaxial fluid fitting 213.

In this embodiment, the cross sectional areas of interior core 492 and exterior annulus 491 are approximately equal. In other embodiments, the cross sectional area of interior core 492 may be larger, smaller, or equal to the cross sectional area of exterior annulus 491. Because the area of a circle increases with the diameter squared, the exterior annulus 491 may have a notably smaller gap thickness than the radius of the interior core 492 while still achieving the same cross sectional area. The diameters are carefully selected to balance fitting size, structural integrity, and pressure drop, but may be, for example, ˜0.2″ interior diameter, ˜0.5″ inner annulus diameter, and ˜0.6″ outer annulus diameter. The diameters may be significantly larger or smaller depending on the system flow rate, available pressure head, and other system performance requirements.

Regardless of size, the diameters may be such that the profile of tube-stop surface 402 of coaxial fluid fitting 213 approximately matches the profile of coaxial fluid transmission element 203 as seen in FIG. 3C. This will ensure minimal additional pressure drop in fluid conveyance from the transmission element to the fluid fitting, and also aid in producing a high quality seal. There may be features on structural members 413 and/or coaxial fluid transmission element 203 that aid to align their matching profiles in a predictable manner upon insertion, and avoid coming out of alignment over time during operation. Such features may be, for example, raised sidewalls on the edges of structural members 413 separated by a gap the size of structural members 330, but other such features may exist.

Fluid streams 291 and 292 may be any fluid, such as a liquid or a gas. In a heat transfer system, for example, the fluid may be single-phase or multiphase. The fluid may be any suitable coolant, including air, water, ethylene glycol, propylene glycol, ethanol, R134A, ammonia, or any other fluid. Other fluids may be applied in different system types. In certain embodiments, the fluid streams 291 and 292 need not be the same, especially, for example, in non-closed loop fluid transmission systems.

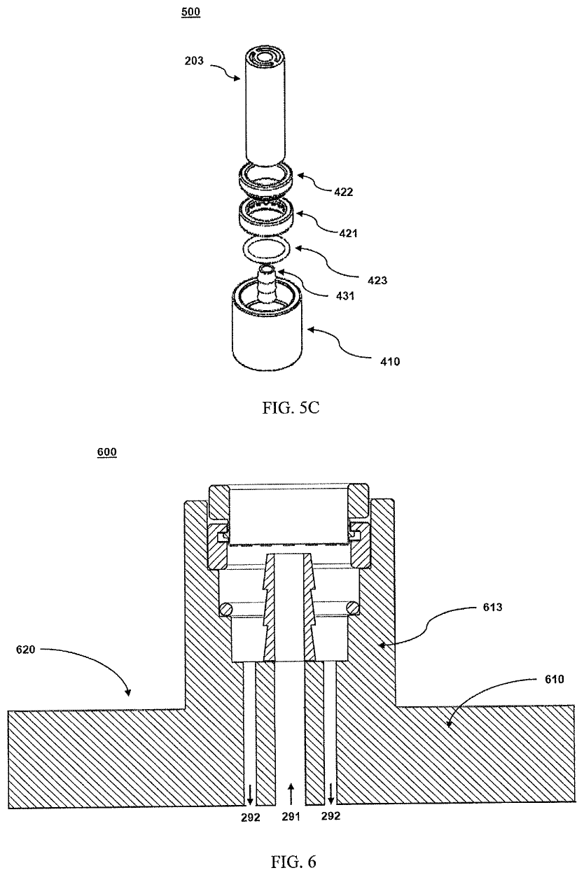

In another embodiment 600, FIG. 6, the fluid-pressure assisted coaxial fluid fitting may be built directly into a component. FIG. 6 shows a fluid-pressure assisted coaxial fluid fitting 613 and a component 610 as part of a single element 620.

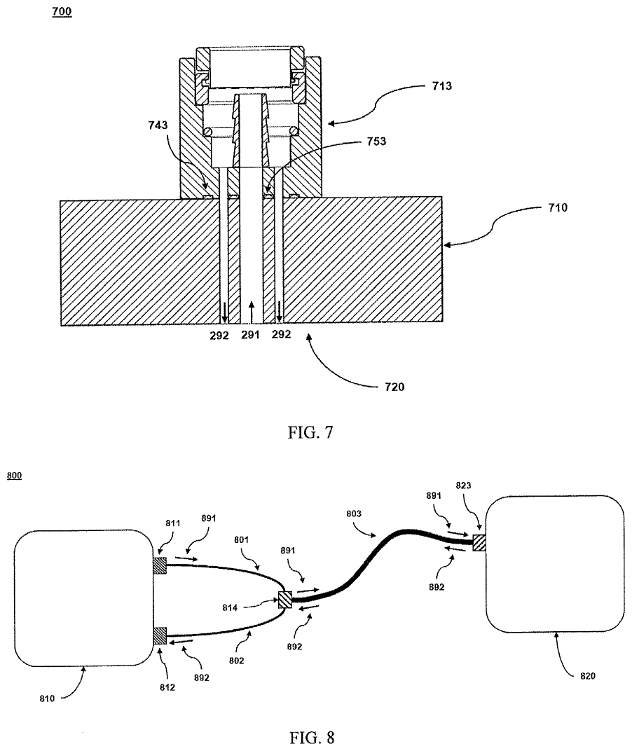

In another embodiment 700, FIG. 7, the fluid-pressure assisted coaxial fluid fitting may be separately attached to a component. In FIG. 7, a fluid-pressure assisted coaxial fluid fitting 713 is attached to component 710 to form assembly 720. In one embodiment, interior fluid stream 291 is sealed via an interior o-ring 753, and exterior fluid stream 292 is sealed via an exterior o-ring 743, compressing the o-rings with a clamping force applied by any suitable method. In other embodiments, the fluid-pressure assisted coaxial fluid fitting may be attached and sealed by the use of epoxies, gaskets, solder, bonding, or any other suitable method.

While coaxial fluid transmission systems may offer improvements in system size, risk, and complexity, there remains a significant infrastructure in fluid transmission systems based on standard, single fluid stream transmission components and fittings. Therefore, there is a potential need for a system and method to adapt between the two infrastructures, both to interface with current systems, as well as provide the strategic capability to apply coaxial elements in conjunction with standard elements.

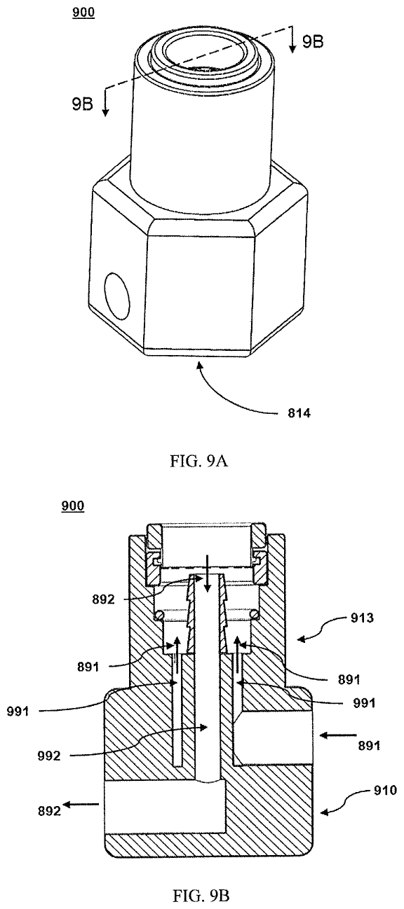

FIG. 8 shows a hybrid transmission system 800 containing both standard and coaxial fluid transmission elements and fittings. Fluid transmission system 800 has two components 810 and 820. The fluid, for example, begins in component 810, passes through standard fitting 811, and enters into standard transmission element 801, traveling toward component 820 in fluid stream 891. The fluid stream 891 then passes through coaxial fluid adapter 814, entering coaxial transmission element 803, still traveling toward component 820 in fluid stream 891. The fluid then passes through coaxial fluid fitting 823 and enters component 820. Upon exiting component 820, the fluid passes back through coaxial fluid fitting 823, separately from fluid stream 891, back into coaxial transmission element 803, traveling back toward component 810 in fluid stream 892. The fluid stream 892 then passes through coaxial fluid adapter 814, separately from fluid stream 891, entering standard transmission element 802, still traveling toward component 810 in fluid stream 892. The fluid then passes through standard fitting 812, re-entering component 810, at which point the closed-loop fluid system repeats. Note that the fluid from stream 891 is the same as the fluid from stream 892, but is separate, switching from stream 891 to stream 892 as it passes through component 820. It does not switch as it passes through adapter 814.

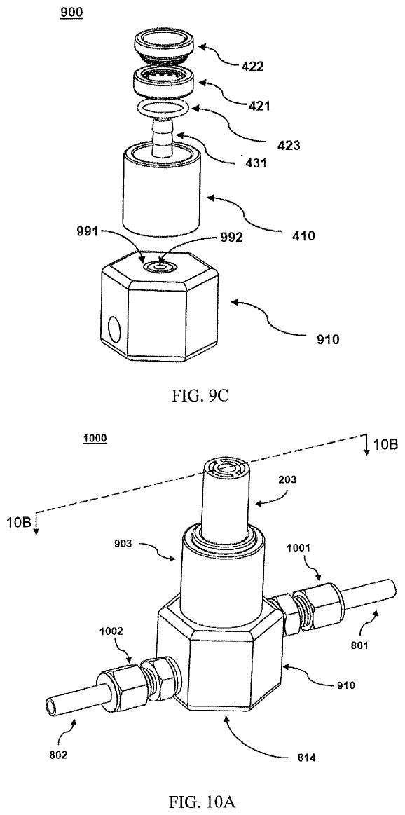

To enable the hybrid system 800, FIGS. 9A-9C show another embodiment 900, which entails a fluid-pressure assisted coaxial fluid adapter 814 from a coaxial fluid transmission element to two standard fluid transmission elements. FIG. 9A shows an isometric view. FIG. 9B shows a cross sectional view. FIG. 9C shows an exploded view.

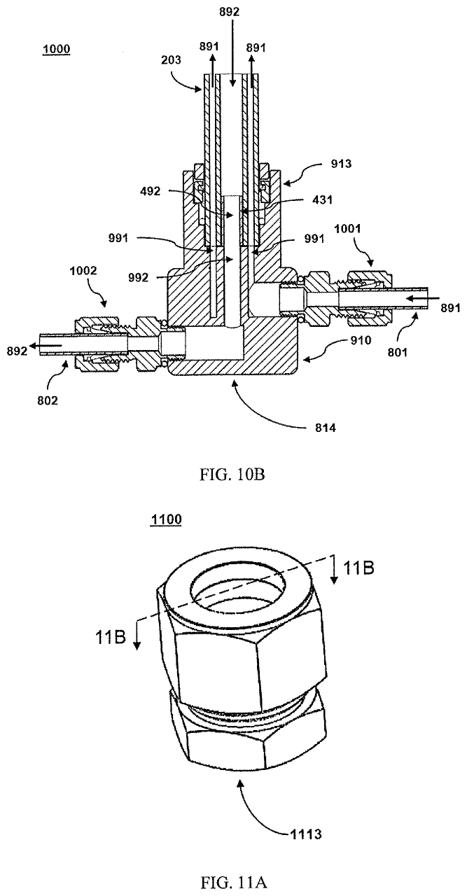

FIGS. 10Aand 10B show an embodiment 1000 of an assembly containing a fluid-pressure assisted coaxial fluid adapter 814, a coaxial fluid transmission element 203, and two standard transmission elements 801 and 802. FIG. 10A shows an isometric view. FIG. 10B shows a cross sectional view.

Looking at FIGS. 10A and 10B, in this embodiment, fluid stream 892 flowing in the interior core 392 of coaxial transmission element 203 travels downward through coaxial transmission element 203, down through hose barb 431 in interior core passageway 492, and down through the interior passage 992 of the adapter 814. Fluid stream 892 then turns to the left, entering into standard fitting 1002, providing conveyance to standard transmission element 802, where it then proceeds to, for example, another component.

Meanwhile, fluid stream 891, traveling the opposite direction as fluid stream 892, enters through standard transmission element 801 into standard fitting 1001, providing conveyance to main body 910 of adapter 814. The flow, originally traveling to the left, turns upward into the concentric annular fluid path 991, best seen in the cross sectional view in FIG. 9B. Fluid path 891 flows in the annular path 991, around and separate from the interior path 992, up into the exterior annulus region 391 of coaxial fluid transmission element 203. Fluid stream 891 then proceeds, for example, to another component, via coaxial fluid transmission element 203.

In this embodiment, standard fittings 1001 and 1002 are straight thread o-ring compression fittings, but may be any suitable fitting type, such as those containing tapered threads, hose barbs, push-to-connect fittings, quick-disconnect fittings, or any other fitting type.

In another embodiment, fittings 1001 and 1002 may be removed, as adapter 814 may be built directly into another manifold or component, or other alternative arrangements of fluid conveyance.

In this embodiment, the two fluid streams 891 and 892 travel in opposite directions; in other embodiments, the fluid streams may travel the same direction through the adapter 814. Also in this embodiment, fluid stream 892 travels downward while fluid stream 891 travels upward; either fluid may travel in either/any direction. Adapter 814 may also support conveyance of the same fluid, such as in a closed-loop system, or entirely different fluids, such as in a non-closed loop system.

The embodiment shown in FIG. 4 depicts connection 420, which creates seal 429, as a push-to-connect fitting. Because the application of a mechanical aid is not constrained for exterior connection 420, other fitting types with external mechanical aids may similarly be applied while creating the same fluid-pressure assist effect.

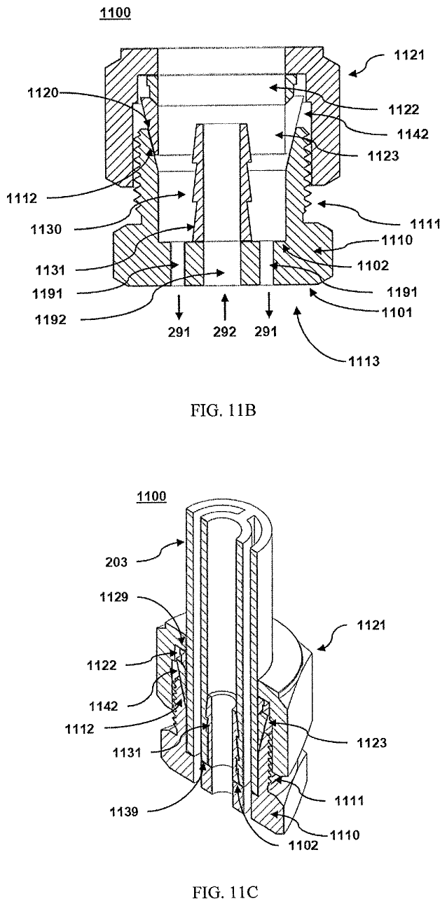

For example, in other embodiments, a coaxial fluid fitting 213 may utilize a compression type fitting as the exterior connection 420 for systems containing even higher pressures, for example, over 1000 PSIg. FIGS. 11A-11C show an embodiment 1100 of a compression fluid-pressure assisted coaxial fluid fitting 1113. FIG. 11A shows an isometric view. FIG. 11B shows a cross sectional view. FIG. 11C shows a cross sectional cutaway view.

The interior connection 1130 is equivalent to that shown in the previous embodiments: coaxial fluid transmission element 203 is inserted to tube stop surface 1102, creating an interference fit between internal wall 310 of the coaxial fluid transmission element 203 and hose barb 1131 to provide a small sealing force. This sealing force is strengthened by the pressure differential formed between high pressure fluid 291 situated in exterior annulus region 391, and low pressure fluid 292 situated in interior core region 392. This creates a fluid-pressure assisted seal as before.

The exterior connection 1120, however, utilizes a compression type sealing mechanism instead of a push-to-connect type sealing mechanism. As seen in FIG. 11B, compression fluid-assisted coaxial fluid fitting 1113 has six major features. For the purpose of explanation, all features are azimuthally symmetric unless otherwise noted.

The first feature is an interior core passageway 1192 where fluid stream 292 travels through compression coaxial fitting 1113. This passage passes through the bottom surface of the main base 1101, past tube-stop surface 1102, and all the way up through hose barb 1131. This passage corresponds to the interior core region 392 of coaxial fluid transmission element 203 containing fluid stream 292.

The second feature is an exterior annular passageway 1191 where fluid stream 291 travels through compression coaxial fitting 1113. This passage passes through the bottom surface of the main base 1101 up to tube-stop surface 1102. This passage corresponds to the exterior annular region 391 of coaxial fluid transmission element 203 containing fluid stream 291.

The third feature is a hose barb 1131. This is part of the mechanism to produce seal 1139 between interior fluid stream 292 and exterior fluid stream 291.

The fourth feature is a compression nut 1121. As will be discussed in greater detail shortly, this is part of a mechanism to produce seal 1129 between exterior fluid stream 291 and the surrounding environment.

The fifth feature is back ferrule 1122. As will be discussed in greater detail shortly, this is part of a mechanism to produce seal 1129 between exterior fluid stream 291 and the surrounding environment.

The sixth feature is front ferrule 1123. As will be discussed in greater detail shortly, this is part of a mechanism to produce seal 1129 between exterior fluid stream 291 and the surrounding environment.

Note that there is at least one structural member (not shown) between interior passageway 1192 and exterior passageway 1191, making the main body 1110 all one connected part. In certain embodiments, the structural members of compression coaxial fluid fitting 1113 may match the structural members 330 of the coaxial fluid transmission element 203 in cross section to avoid interrupting fluid stream 291 in the exterior annulus 391. These features, therefore, would not be azimuthally continuous but may be in a regular azimuthal pattern.

Now looking at FIG. 11C, seal 1129 via compression connection 1120 is formed as follows. Coaxial transmission element 203 is inserted to tube stop surface 1102, initially providing no exterior seal 1129. The back ferrule 1122 is mated with the front ferrule 1123 surrounding coaxial transmission element 203, with compression nut 1121 sitting over them. The compression nut 1121 is then torqued a specified amount on threads 1111 of main body 1110. As the compression nut is torqued and travels down the threads 1111, a force is transmitted through back ferrule 1122 to front ferrule 1123, causing the interior of front ferrule 1123 to pinch the external wall 320 of coaxial fluid transmission element 203 and create a strong interference fit as external wall 320 permanently deflects inward. Simultaneously, the flared surface 1142 of front ferrule 1123 is mated with flared surface 1112 of main body 1110, causing a very strong sealing force via the torqued compression nut 1121 on the threads 1111. This connection 1120, though caused by a permanent alteration of the coaxial fluid transmission element external wall 320, is fully reversible as the compression nut 1121 may be un-tightened and re-tightened anew, establishing the strong exterior seal 1129 (over 1000 PSIg) via the mating of flared surfaces 1112 and 1142.

Note that this is one embodiment of a compression fluid connection 1120; there may be compression fittings with different shaped ferrules, or a different number of ferrules, for example. There may also be tube inserts to aid with the creation of the compression connection for certain coaxial fluid transmission element materials.

Regardless, this is an illustration showing another system and method of providing a mechanical aid to the exterior seal, of which there are others that may be applied. Simply put, the same fluid-pressure assist is sustained to strengthen the interior seal, allowing coaxial fluid transmission elements to be applied in fluid transmission systems with pressurized fluids in a single fitting. All other embodiments discussed previously may replace push-to-connect embodiment 213 with compression embodiment 1113 and serve the same purpose.

To summarize, a variety of embodiments of fluid-pressure assisted coaxial fluid elements were presented and explained. One coaxial fluid transmission element embodiment 203 seen in FIG. 3, and one coaxial fluid fitting 213 in FIG. 4, contain pressurized fluid streams of different pressures, situating the higher pressure fluid in the exterior annulus region. Where normally a multi-lumen tube would have difficulty creating a high quality interior seal because of interference in applying a mechanical sealing aid, the pressure differential of the exterior and interior fluid streams in this coaxial arrangement produces a net inward force to replace or augment the mechanical aid and produce a high quality seal. This enables the use of coaxial fluid transmission elements in pressurized fluid transmission systems, reducing the size, number of failure points, and complexity of fluid transmission systems.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes.

What is claimed is:

1. A fluid-pressure assisted coaxial fluid fitting, configured to accept a coaxial fluid transmission element, comprising:
a first, interior seal, configured to seal a circular interior region of a coaxial fluid transmission element containing a fluid at a first pressure; and
a second, exterior seal, configured to seal at least one exterior non-circular region of a coaxial fluid transmission element containing a fluid at a second pressure higher than the first pressure;
wherein the fluid at the second, higher pressure provides a fluid-pressure assist on the first interior seal.

2. The fluid-pressure assisted coaxial fluid fitting of claim 1, wherein the interior seal is formed by a fluid-pressure assisted barb type connection.

3. The fluid-pressure assisted coaxial fluid fitting of claim 1, wherein the exterior seal is formed by a push-to-connect type connection.

4. The fluid-pressure assisted coaxial fluid fitting of claim 1, wherein the exterior seal is formed by a compression type connection.

5. The fluid-pressure assisted coaxial fluid fitting of claim 1, configured to serve as an adapter to interface with two standard single-lumen transmission elements.

6. The fluid-pressure assisted coaxial fluid fitting of claim 1, forming part of a fluidic component such that the fluid fitting and fluidic component are a unitary structure.

7. The fluid-pressure assisted coaxial fluid fitting of claim 1, configured to interface with a fluidic component via a gasket seal.

8. The fluid-pressure assisted coaxial fluid fitting of claim 1, configured to interface with a fluidic component via a threaded connection.

9. An assembly, comprising:
a coaxial fluid transmission element, comprising:
an interior circular core region containing a fluid at a first pressure; and
at least one exterior non-circular region, surrounding at least most of the interior core region, containing a fluid at a second pressure that is higher than the first pressure; and
a fluid-pressure assisted coaxial fluid fitting, configured to accept the coaxial fluid transmission element, comprising:
a first interior seal, configured to seal the circular interior region of the coaxial fluid transmission element containing the fluid at the first pressure; and
a second exterior seal, configured to seal the at least one exterior non-circular region of the coaxial fluid transmission element containing a fluid at the second pressure higher than the first pressure;
wherein the fluid at the second, higher pressure provides a fluid-pressure assist on the first seal.

10. The assembly of claim 9, wherein the coaxial fluid fitting further comprises mechanical features that are configured to align the coaxial fluid transmission element with the coaxial fluid fitting upon insertion of the coaxial fluid transmission element into the coaxial fluid fitting.

11. The assembly of claim 9, configured to be an adapter between a coaxial tube and at least two standard tubes that each comprise a single lumen, and further comprising:
a first standard tube containing a fluid;
a second standard tube containing a fluid at a pressure that is higher than that of the first standard tube;
a first standard fitting, providing a seal for the first standard tube;
a second standard fitting, providing a seal for the second standard tube;
wherein the first fitting provides transmission of the fluid in the first standard tube to the interior circular core region; and
wherein the second fitting provides transmission of the fluid in the second standard tube to the at least one non-circular region.

12. The assembly of claim 11, wherein the first and second standard fluid fittings are of the same type.

13. The assembly of claim 11, wherein the first and second standard fluid fittings are of different types.

14. The assembly of claim 11, wherein at least one of the first and second standard fluid fittings is a non-fluid-pressure assisted barb fitting.

15. The assembly of claim 11, wherein at least one of the first and second standard fluid fittings is a compression fitting.

16. The assembly of claim 11, wherein at least one of the first and second fluid fittings is a push-to-connect fitting.

17. The assembly of claim 11, wherein at least one of the first and second standard fluid fittings is a quick disconnect fitting.

18. The assembly of claim 9, comprising a material with low thermal conductivity to reduce heat transfer between fluid streams of different temperatures.

19. The assembly of claim 9, comprising an inner wall that separates the interior region from the at least one exterior region, and an outer wall that defines the outside of the at least one exterior region, with at least one structural member between the inner wall and the outer wall.

20. The assembly of claim 19, wherein the inner wall and the outer wall are made from different materials.

21. The assembly of claim 20, made by a co-extrusion technique.

22. The assembly of claim 19, wherein the material of the inner wall is compatible with a hose barb type connection.

23. The assembly of claim 19, wherein the material of the outer wall is compatible with a push-to-connect type connection.

24. The assembly of claim 19, wherein the material of the outer wall is compatible with a compression type connection.

25. The assembly of claim 19, wherein the material of the inner wall has a low thermal conductivity, to inhibit heat transfer between fluid streams of different temperatures.
